(19) United States
(12) Patent Application Publication
(10) Pub. No.: US 2021/0000095 A1
(43) Pub. Date: Jan. 7, 2021

(54) ENCLOSURE FOR AN ELECTRONIC DEVICE IN A FISHING ROD

(71) Applicant: Pure Fishing, Inc., Spirit Lake, IA (US)

(72) Inventor: Christopher Andrew Cathcart, Irmo, SC (US)

(21) Appl. No.: 16/915,305

(22) Filed: Jun. 29, 2020

Related U.S. Application Data
(60) Provisional application No. 62/869,638, filed on Jul. 2, 2019.

(51) Int. Cl. A01K 87/00; A01K 97/12

(52) U.S. Cl. CPC A01K 87/007; A01K 97/125

(57) ABSTRACT

An enclosure for an electronic device such as a light or bite indicator is provided that may be positioned and located on a “butt” end of a fishing rod (nearer to the reel). The enclosure includes two securing members that may be threaded to one another or snapped together to form a cavity there between. The first securing member includes a post that engages with the rod, and the post may be permanently attached to the butt end of the fishing rod. The second securing member may be threaded onto or snapped together with the first securing member to form the cavity, and the securing members may be sealed to one another using rubber seals to increase water-tightness of the cavity.

### CROSS-REFERENCE TO RELATED APPLICATIONS

This application claims priority to U.S. Provisional Patent Application Ser. No. 62/869,638, filed on Jul. 2, 2019, entitled “ENCLOSURE FOR AN ELECTRONIC DEVICE IN A FISHING ROD” currently pending, the entire disclosure of which is incorporated herein by reference

### BACKGROUND OF INVENTION

Many fishing rods incorporate electronic devices that improve the fishing experience. Commonly used electronic devices may include lights, fish finders, and bite indicators, to name a few. The electronic devices are typically provided in enclosures within the fishing rod so as to increase the likelihood that the devices are not exposed to water and subsequently damaged.

In fishing rods currently or previously on the market, the electronics are sometimes permanently enclosed within an enclosure of the rod. In those example embodiments, accessing the electronics for adjustment or replacement is not possible without at least partially destroying the enclosure.

In other example enclosures, the electronic device is enclosed in a separate unit that is not integrated into the structure of the rod. The unit may be selectively attachable to the rod, which increases its risk of falling off of the rod and breaking, falling into water, or otherwise getting lost. It also may require an angler to install and remove the unit every time that he or she fishes or stows his or her gear.

### SUMMARY OF THE INVENTION

The improved enclosure for an electronic device (including but not limited to communication devices, light bulbs, noisemakers/sensors to detect a fish on the line) described herein may be positioned and located on a “butt” end of a fishing rod (nearer to the reel). The enclosure may include a first threaded securing member with a post that extends inwardly toward the rod, wherein the post may be permanently or removably attached to the butt end of the fishing rod. A second securing member that may be embodied as a cap may be threaded onto, snapped together with, or otherwise attached to the first securing member. The two securing members together form a cavity to hold an electronic device such as a communication device, light, fish sensor, or the like. The securing members may be sealed to one another by using rubber or similar material on each end to prevent water intrusion into the cavity.

Advantageously, the current invention is inconspicuously built into the assembly of the rod so that it is slim and looks like part of the rod or rod handle. It also has features to allow removal of the electronic device in the event that it is in need of repair or replacement. The enclosure also allows the electronic device to be manually activated, and it is protected from water intrusion by a rubber seal, or like material.

### DESCRIPTION OF THE DRAWINGS

For a better understanding of the various embodiments of the present invention, reference may be made to the accompanying drawings in which:

FIG. 1 is a perspective view of a proximal portion of a fishing rod and an enclosure for an electronic device built into the fishing rod according to the teachings hereof;

FIG. 2 is a cross-section view of the enclosure for an electronic device of FIG. 1;

FIG. 2A is an alternative cross-section view of the enclosure for an electronic device of FIG. 2;

FIG. 3 is an exploded cross-section view of the enclosure for an electronic device of FIGS. 1 and 2; and

FIG. 4 is an exploded view of the enclosure for an electronic device of FIGS. 1-3.

While the disclosure is susceptible to various modifications and alternative forms, a specific embodiment thereof is shown by way of example in the drawings and will herein be described in detail. It should be understood, however, that the drawings and detailed description presented herein are not intended to limit the disclosure to the particular embodiment disclosed, but to the contrary, the intention is to cover all modifications, equivalents, and alternatives falling within the spirit and scope of the present disclosure as defined by the appended claims.

### DETAILED DESCRIPTION OF THE INVENTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

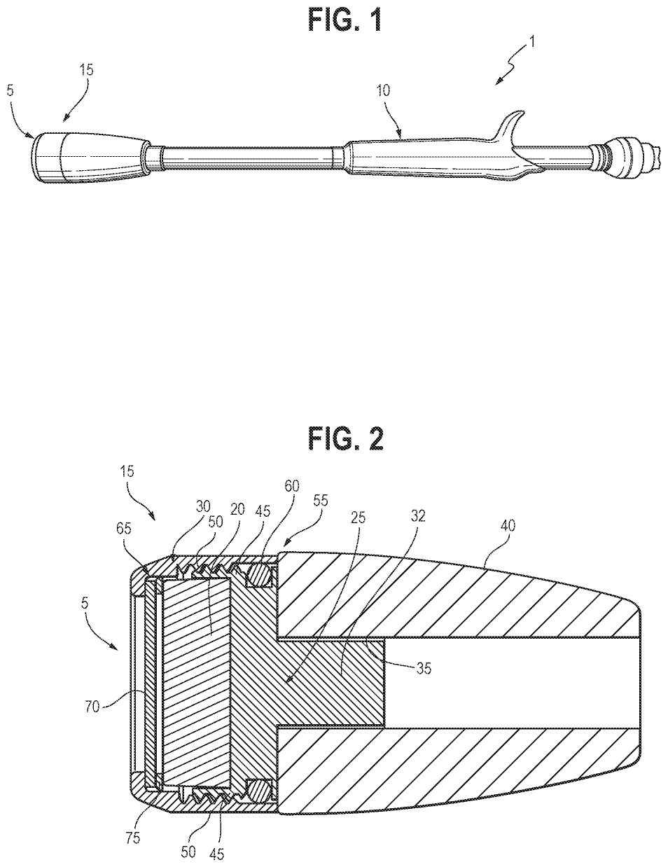

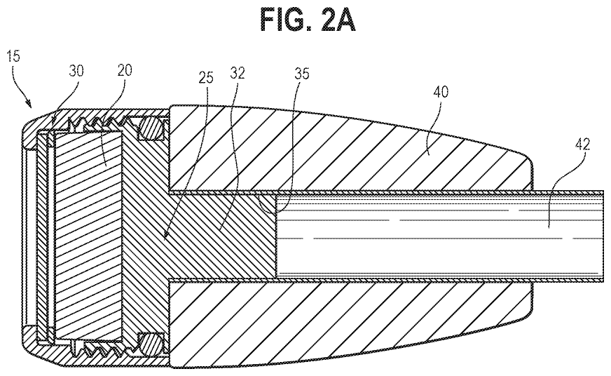

Referring to the drawings, FIG. 1 illustrates a portion of a fishing rod 1, the components and construction of which will be described below. A proximal end 5 (referred to herein also as a “butt end 5”) of the rod 1, nearer to where a reel (not illustrated) would be attached to the rod 1 is illustrated in FIG. 1. The fishing rod 1, like conventional rods, includes a handle portion 10 where an angler may grasp the rod 1 when carrying the rod 1 or fishing. The fishing rod 1 also includes an enclosure 15 for an electronic device 20 (illustrated in FIG. 2) at its butt end 5.

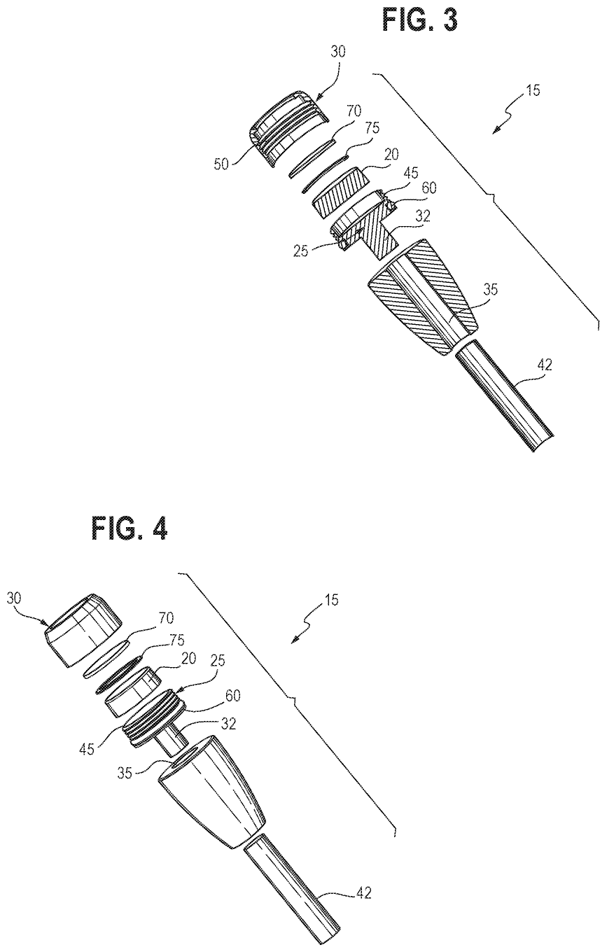

Turning to FIGS. 2, 3, and 4, the enclosure 15 is illustrated in greater detail. The enclosure 15 includes an electronic device 20 that is secured therein between a first securing member 25 and a second securing member 30. The electronic device 20 may be a variety of different types of electronic devices, including but not limited to, lights, fish finders, and bite indicators. The electronic device 20 may automatically sense activation from an angler or be manually activated by an angler. The electronic device 20 may further communicate with secondary devices such as phones, tablets, etc. or have processing capabilities incorporated therein.

In the embodiment illustrated in FIG. 2, the first securing member 25 includes a post member 32 that may be integrally formed with, or otherwise attached to, the securing member 25. The post member 32 may be received within a cavity 35 of a rear fishing grip 40 of the rod 1 or a rod blank itself (such as rod blank 42 of FIGS. 2A, 3 and 4). In a first embodiment, the post member 32 may be of a circumference that is only slightly larger than that of the cavity 35 so that it may be selectively engageable therewith via a tight friction fit. The fit between the post member 32 and the cavity 35 should be sufficiently tight that the post member 32 (and first securing member 25) will not independently fall out of the cavity 35. In one embodiment, it should be removable if pulled with sufficient force, should the enclosure 5 and/or its electronic device 20 therein be in need of replacement or repair. In another alternative embodiment, the post member 32 may be permanently or semi-permanently attached within the cavity 35 (e.g., by an adhesive) and not removable therefrom.

Nearer the butt portion 5 of the rod 1, the first securing member 25 may be provided with thread members 45 that may be selectively engageable with thread members 50 of the second securing member 30. The thread members 45, 50 may be engaged with one another using a known threaded engagement mechanism to thus engage the securing members 25, 30 to one another. When the securing members 25, 30 are engaged to one another, the electronic device 20 is preferably secured between the securing members 25, 30.

In at least one embodiment (and as illustrated), the second securing member 30 is provided as a cap that may be selectively engageable with the first securing member 25. In an alternative embodiment, the electronic device 20 may be integrally built into the second securing member 30 so that if the electronic device 20 needs to be replaced, one may simply replace the entire securing member 30 (and the electronic device 20).

At a first distal attachment point 55 between the securing members 25, 30, a seal member 60 may be provided. The seal member 60 may be embodied as an O-ring or other rubber or rubber-like sealing mechanism to improve the watertight nature of the enclosure 15. Similarly, at a second proximal attachment point 65 between the securing members 25, 30, a second seal member 70 may also be provided. Like the seal member 60, the seal member 70 may be embodied as a disc-shaped seal, O-ring, or other rubber or rubber-like sealing mechanism to improve the watertight nature of the enclosure 15. In addition, an optional spacer 75, which may be embodied as a washer may also be located between the seal member 70 and the electronic device 20 to keep the electronic device 20 from jostling too much when in use and to provide a water-tight seal between the seal 70 and the enclosure 50. The optional spacer 75 may take on a nearly limitless number of shapes and sizes to carry out its intended function of securing the electronic device 20.

The enclosure 15 is thus configured such that when an angler needs to replace or repair the electronic device 20, he or she may remove the entire enclosure 15 by pulling the post member 32 from the cavity 35. Alternatively, he or she may remove the second securing member 30 from the enclosure 15 to access the electronic device 20.

From the foregoing, it will be seen that the various embodiments of the present invention are well adapted to attain all the objectives and advantages hereinabove set forth together with still other advantages which are obvious and which are inherent to the present structures. It will be understood that certain features and sub-combinations of the present embodiments are of utility and may be employed without reference to other features and sub-combinations. Since many possible embodiments of the present invention may be made without departing from the spirit and scope of the present invention, it is also to be understood that all disclosures herein set forth or illustrated in the accompanying drawings are to be interpreted as illustrative only and not limiting. The various constructions described above and illustrated in the drawings are presented by way of example only and are not intended to limit the concepts, principles and scope of the present invention.

As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required.”

Many changes, modifications, variations and other uses and applications of the present constructions will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An enclosure for an electronic device that is engageable with a fishing rod, the enclosure comprising:
a first securing member selectively engageable with a proximal end of the fishing rod;
a second securing member selectively engageable with the first securing member; and
wherein when the first securing member and the second securing member are engaged with one another, a cavity is formed between the first securing member and the second securing member for receiving and securing the electronic device.

2. The enclosure of claim 1, wherein the cavity is waterproof.

3. The enclosure of claim 1, wherein the electronic device is integrally formed with at least one of the first securing member and the second securing member.

4. The enclosure of claim 1, wherein the first securing member includes a post member that is receivable in the proximal end of the fishing rod.

5. The enclosure of claim 1, wherein the first securing member and the second securing member are selectively engageable via threads.

6. The enclosure of claim 1, wherein the electronic device is one of a light, fish finder, and bite indicator.

7. The enclosure of claim 1, wherein the enclosure includes a spacer that further secures the electronic device.

8. An enclosure for an electronic device that is engageable with a fishing rod, the enclosure comprising:
a first securing member selectively engageable with a proximal end of the fishing rod;
a second securing member selectively engageable with the first securing member; and
a cavity formed between the first securing member and the second securing member for receiving and securing the electronic device.

9. The enclosure of claim 8, wherein the cavity is waterproof.

10. The enclosure of claim 8, wherein the electronic device is integrally formed with at least one of the first securing member and the second securing member.

11. The enclosure of claim 8, wherein the first securing member includes a post member that is receivable in the proximal end of the fishing rod.

12. The enclosure of claim 8, wherein the first securing member and the second securing member are selectively engageable via threads.

13. The enclosure of claim 8, wherein the electronic device is one of a light, fish finder, and bite indicator.

14. The enclosure of claim 8, wherein the enclosure includes a spacer that further secures the electronic device.

15. A method for assembling an enclosure for an electronic device that is engageable with a fishing rod, the method comprising the steps of:
selectively engaging a first securing member with a proximal end of the fishing rod;
selectively engaging a second securing member with the first securing member to form a cavity between the first securing member and the second securing member for receiving and securing the electronic device therein.
